(19) United States
(12) Patent Application Publication
(10) Pub. No.: US 2006/0072341 A1
(43) Pub. Date: Apr. 6, 2006

(54) Transflective brightening plate and double-face lighting backlight module using the transflective brightening plate

(76) Inventors: Kuo-Jui Huang, Dali City (TW); Ping Yen Chen, Fongyuan City (TW); Chong Yang Fang, Sinying City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/952,585

(22) Filed: Sep. 29, 2004

(51) Int. Cl. F21V 7/04

(52) U.S. Cl. 362/620

(57) ABSTRACT

A transflective brightening plate and a double-face lighting backlight module to which the transflective brightening plate is applied. The transflective brightening plate includes multiple brightening structures on one face of a substrate. The brightening structures are light-guiding structures as micro-prisms. A transflective coating is disposed on the other face of the substrate. The light is partially reflected by the transflective coating and partially penetrates through the transflective coating.

### BACKGROUND OF THE INVENTION

The present invention is related to a transflective brightening plate and a double-face lighting backlight module using the transflective brightening plate. A substrate is co-used by the brightening structures and the transflective coating of the transflective brightening plate so as to reduce the thickness of the transflective brightening plate.

FIGS. 4 and 5 show a backlight module applied to conventional double-face display. A transflective plate 72 is disposed on one side of the light-guiding board 71 for saving power and reducing the thickness of the backlight module. A scattering plate 73 is disposed on one face of the transflective plate 72 distal from the light-guiding board 71. Another scattering plate 73 is disposed on one face of the light-guiding board 71 distal from the transflective plate 72. Two sets of brightening plates 74 are respectively disposed on two opposite faces of the scattering plates 73. (Each set includes two brightening plates.) Such backlight module includes eight layers so that in manufacturing and assembling, more locating procedures are required. Therefore, the possibility of error of location is increased. In addition, the transflective plate 72 includes a substrate 721 and a transflective coating 722 deposited on the substrate 721. Also, the brightening plate 74 has another independent substrate. Therefore, the entire backlight module includes multiple independent substrates so that the thickness of the backlight module is increased. FIG. 6 shows another type of double-face lighting module in which only one scattering plate 82 is disposed on one side of the double-face lighting light-guiding board 81. A transflective plate 83 is disposed on the other side of the light-guiding board 81. In such structure, one scattering plate 82 is omitted. However, the number of the brightening plates 84 cannot be reduced. Therefore, the cost for the backlight module cannot be lowered and the thickness of the backlight module as a whole cannot be reduced.

### SUMMARY OF THE INVENTION

It is therefore a primary object of the present invention to provide a transflective brightening plate and a double-face lighting backlight module using the transflective brightening plate. A substrate is co-used by the brightening structures and the transflective coating of the transflective brightening plate. Therefore, the thickness of the transflective brightening plate is much less than the thickness of the conventional transflective plate plus the brightening plates. In addition, the conventional transflective plate and brightening plates are replaced with the transflective brightening plate so that the cost for the backlight module is lowered. Moreover, the number of the layers of the entire backlight module is reduced so that the error of assembly can be reduced.

According to the above object, the transflective brightening plate of the present invention is disposed on one face of a double-face lighting light-guiding board. The transflective brightening plate includes a brightening section having multiple brightening structures on one face of the substrate. The brightening structures are light-guiding structures as micro-prisms. A transflective coating is disposed on an opposite face of the substrate distal from the brightening section. The light is partially reflected by the transflective coating and partially penetrates through the transflective coating.

The present invention can be best understood through the following description and accompanying drawings wherein:

### BRIEF DESCRIPTION OF THE DRAWINGS

FIG. 1 shows the structure of the transflective brightening plate of the present invention;

FIG. 2 shows the light path of the transflective brightening plate of the present invention;

FIG. 3 shows that the transflective brightening plate of the present invention is applied to a double-face lighting backlight module;

FIG. 4 shows the structure of the backlight module of a conventional double-face display;

FIG. 5 shows the light path of the transflective plate and brightening plate of FIG. 4; and

FIG. 6 shows the structure of the backlight module of another type of conventional double-face display.

### DETAILED DESCRIPTION OF THE PREFERRED EMBODIMENT

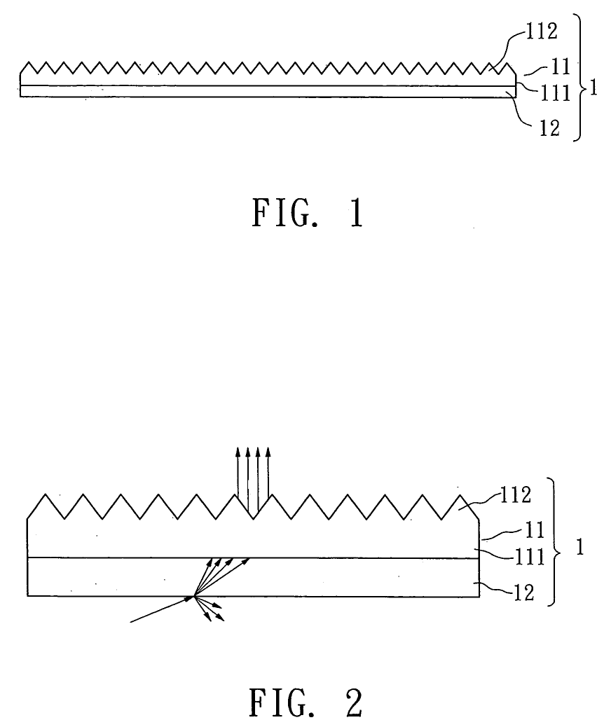

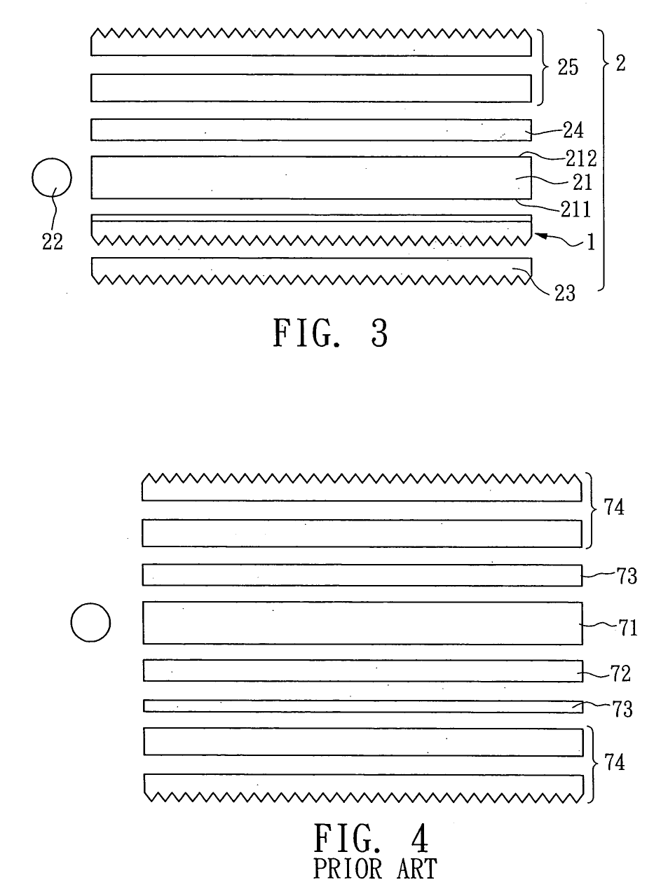

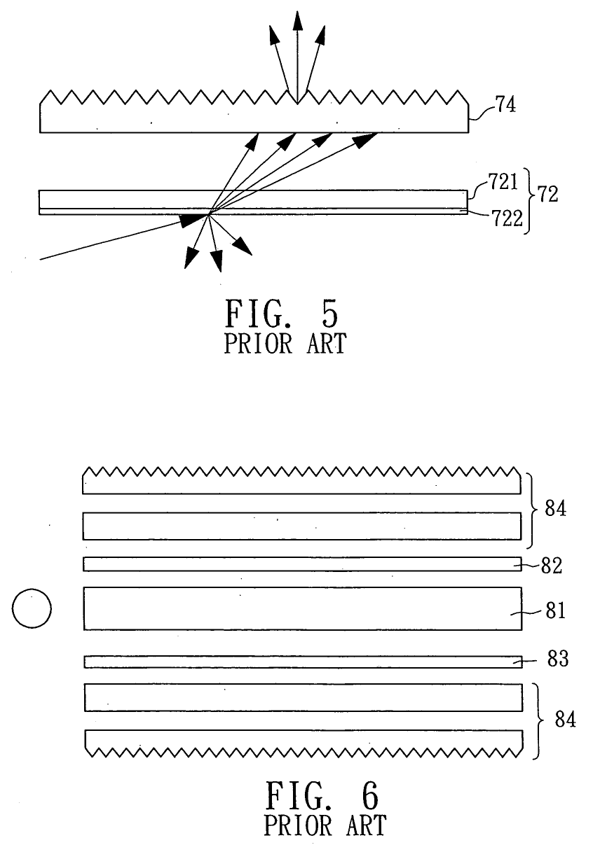

Please refer to FIGS. 1 to 3. The transflective brightening plate 1 of the present invention includes a brightening plate 11. The brightening plate 11 has multiple brightening structures 112 on one face of a substrate 111. The brightening structures 112 are light-guiding structures as micro-prisms. A transflective coating 12 is disposed on the opposite face of the substrate 111 distal from the brightening structures 112. The transflective coating 12 is deposited on the substrate 112, whereby the light is partially reflected by the transflective coating 12 and partially penetrates there through.

The transflective brightening plate 1 is disposed in a backlight module 2 including a double-face lighting light-guiding board 21 with double-face light-guiding effect. The double-face lighting light-guiding board 21 includes a first lighting face 211 and a second lighting face 212 corresponding to each other. In this embodiment, the first lighting face 211 is disposed under the bottom of the double-face lighting light-guiding board 21, while the second lighting face 212 is disposed on the top of the double-face lighting light-guiding board 21. A light source 22 is positioned on one side of the double-face lighting light-guiding board 21, which side is free from the first and second lighting faces 211, 212. The transflective brightening plate 1 and a brightening plate 23 are sequentially underlaid below the first lighting face 211 of the double-face lighting light-guiding board 21. The brightening plate 23 is attached to the brightening structures 112 of the transflective brightening plate 1. The transflective coating 12 is adjacent to the double-face lighting light-guiding board 21. In addition, a scattering plate 24 and two overlapping upper brightening plates 25 are sequentially piled on the top of the double-face lighting light-guiding board 21.

In practice, main display module and subsidiary display module (not shown) are respectively disposed on the top and bottom of the backlight module 2. In use, a part of the light emitted from the light source 22 is guided by the double-face lighting light-guiding board 21 and refracted to the top face of the double-face lighting light-guiding board 21 and projected out therefrom. The light projected from the top face is further guided by the scattering plate 24 and the brightening plates 25 to the main display module. Therefore, the main display module can provide backlight display effect. On the other hand, another part of the light emitted from the light source 22 is guided by the double-face lighting light-guiding board 21 to the bottom. The part of the light guided to the bottom is partially reflected by the transflective coating 12 of the transflective brightening plate 1 back to the double-face lighting light-guiding board 21 and guided by the double-face lighting light-guiding board 21 to the main display module. The part of light guided to the bottom also partially penetrates through the transflective coating 12. The brightening structures 112 of the transflective brightening plate 1 serve to focus the light and guide the light in a direction of visual angle. The light is then brightened by the brightening plate 23 so that the subsidiary display module can provide backlight effect.

The substrate 111 is co-used by the brightening structures 112 and the transflective coating 12 of the transflective brightening plate 1. Therefore, the thickness of the transflective brightening plate is much less than the thickness of the conventional transflective plate plus the brightening plates. In addition, the conventional transflective plate and brightening plates are replaced with the transflective brightening plate so that the cost for the backlight module is lowered. Moreover, the number of the layers of the entire backlight module is reduced so that the error of assembly can be reduced.

The above embodiment is only used to illustrate the present invention, not intended to limit the scope thereof. Many modifications of the above embodiment can be made without departing from the spirit of the present invention.

What is claimed is:

1. A transflective brightening plate comprising a brightening section having multiple brightening structures on one face of a substrate, the brightening structures being light-guiding structures as micro-prisms, a transflective coating being disposed on an opposite face of the substrate distal from the brightening section, whereby the light is partially reflected by the transflective coating and partially penetrates through the transflective coating.

2. The transflective brightening plate as claimed in claim 1, wherein the transflective coating is deposited on the substrate.

3. A double-face lighting backlight module using the transflective brightening plate as claimed in claim 1, the backlight module comprising a double-face lighting light-guiding board with double-face light-guiding effect, the double-face lighting light-guiding board including two lighting faces corresponding to each other, the transflective brightening plate being disposed on one of the lighting faces, a light source being positioned on one side of the double-face lighting light-guiding board, which side is free from the two lighting faces.
